(19) United States
(12) Patent Application Publication
(10) Pub. No.: US 2012/0136584 A1
(43) Pub. Date: May 31, 2012

(54) DETECTION APPARATUS AND DETECTION METHOD FOR DETECTING MICROORGANISMS

(76) Inventors: Kazuo Ban, Osaka-shi (JP); Kazushi Fujioka, Osaka-shi (JP); Norie Matsui, Osaka-shi (JP); Shuhji Nishiura, Osaka-shi (JP); Hiroki Okuno, Osaka-shi (JP); Katsutoshi Takao, Osaka-shi (JP)

(21) Appl. No.: 13/388,934

(22) PCT Filed: Jul. 26, 2010
(86) PCT No.: PCT/JP2010/062524

§ 371 Date: Feb. 3, 2012

(30) Foreign Application Priority Data
Aug. 4, 2009 (JP) 2009-181589

(51) Int. Cl. G01N 21/49; G06F 19/00

(52) U.S. Cl. 702/21; 702/19

(57) ABSTRACT

A light receiving element provides a current signal corresponding to an amount of received light scattered by suspended particles moving at a predetermined speed to a pulse width measurement circuit and a current-voltage conversion circuit via a filter circuit. A pulse width measured from the current signal is converted into a voltage value based on a predetermined relationship by a pulse width-voltage conversion circuit, and is provided to a voltage comparison circuit. The current-voltage conversion circuit converts a peak value of the current signal into a voltage value, and an amplifier circuit amplifies the signal at a predetermined amplification factor and provides the same to the voltage comparison circuit. The voltage comparison circuit uses the voltage value converted from the pulse width as a boundary value, and the suspended particles causing the scattered light are detected as microorganisms when the peak voltage value is smaller than the boundary value.

### TECHNICAL FIELD

The present invention relates to a detection apparatus and a detection method, and particularly to a device for detecting microorganisms that are biological particles suspended in an air as well as a detection method.

### BACKGROUND ART

Conventionally, for detecting airborne microorganisms, first, airborne microorganisms are collected by sedimentation, impaction, slit method, using perforated plate, centrifugal impaction, impinger or filteration and, thereafter, the microorganisms are cultivated and the number of appeared colonies is counted, By such a method, however, two or three days are necessary for cultivation and, therefore, detection on real-time basis is difficult.

Recently, apparatuses for measuring numbers by irradiating airborne microorganisms with ultraviolet ray and detecting light emitted from microorganisms have been proposed, for example, in Japanese Patent Laying-Open No. 2003-38163 (Patent Literature 1) and Japanese Patent National Publication No. 2008-508527 (Patent Literature 2). By way of example, the Patent Literature 1 will be discussed below in detail with reference to FIG. 13. In this device, a suction pump 111 introduces an external air into the device. The air introduced to a vicinity of a nozzle 120 is irradiated with infrared beams of a sheet-like form that are radiated from an infrared semiconductor laser 112 through a collimate lens 115 and a cylindrical lens 116. The infrared beams are scattered by suspended particles in the air, and are detected by light receiving element 114 through an infrared-transparent filter 113. Meanwhile. ultraviolet rays radiated from an ultraviolet LED 117 pass through a collimate lens 118 and a cylindrical lens 119 to take a sheet-like form, and impinges on the air near nozzle 120. When the suspended particles are of biological origin, the suspended particles emit fluorescence, which is detected by a light receiving element 122 after passing through a band-path filter 121 passing only the fluorescence. A circuit structure shown in FIG. 14 processes signals provided from light receiving elements 114 and 122. When both the elements issue signals, the suspended particles are of biological origin. When only light receiving element 114 issues the signal, they are not of biological origin. Utilizing the above, the device can detect in real time the suspended particles of biological origin, i.e., the microorganisms.

### Patent Literature

### PTL 1: Japanese Patent Laying-Open No. 2003-38163

### PTL 2: National Publication No. 2008-508527

### SUMMARY OF INVENTION

### Technical Problem

Actually, however, dust suspended in the air includes much lint of chemical fibers. The chemical fibers emit fluorescence when irradiated with ultraviolet ray. Therefore, when the determination whether the irradiation with the ultraviolet rays causes the emission of the fluorescence or not is employed in a method, as disclosed in the Patent Literature 1, for determining whether the suspended particles are of biological origin or not, this method detects the dust emitting fluorescence in addition to the biological suspended particles existing in the air. Therefore, the conventional device that employs the above method such as the device in the Patent Literature 1 suffers from a problem that it cannot accurately evaluate only the biological suspended particles existing in the air.

The invention has been made in view of the above problem, and it is an object of the invention to provide a detection apparatus and a detection method that can accurately detect the biological suspended particles existing in the air.

### Solution to Problem

For achieving the above object, according to an aspect of the invention, a detection apparatus for detecting particles of biological origin among particles suspended in an air includes a light emitting element; a light receiving unit having a light receiving direction forming a predetermined angle with respect to a radiation direction of the light emitting element; a processing device for processing a quantity of received light of the light receiving unit as a detection signal; and a storage device. When the processing device accepts input of the detection signal representing the received light amount of the light receiving unit, the processing device executes processing of comparing the detection signal with an arbitrary condition, and thereby determining whether the particles suspended in the air are of biological origin or not, and stores a result of the determination in the storage device.

Preferably, the processing device determines, in the processing of performing the determination, whether sizes of the particles suspended in the air obtained from the detection signal and an amount of light scattered by the particles suspended in the air satisfy the arbitrary condition or not, and thereby determines whether the particles suspended in the air are the particles of biological origin or not.

Preferably, the arbitrary condition is a boundary value corresponding to a pulse width of the detection signal, and the processing device compares, in the processing of performing the determination, a peak value of the detection signal with the boundary value corresponding to the pulse width of the detection signal, and determines, based on a result of the comparison, whether the particles suspended in the air are the particles of biological origin or not.

More preferably, the processing device includes a conversion device for storing, as the arbitrary condition, a correlation between the pulse width and the boundary value, and converting the pulse width of the detection signal into the boundary value based on the correlation.

More preferably, the detection apparatus further includes an input device for accepting the input of the correlation.

More preferably, the processing device further executes processing of updating the stored correlation.

Preferably, the processing device includes a pulse width measuring circuit for measuring the pulse width from the received detection signal; a pulse width-voltage conversion circuit for converting a pulse width value provided from the pulse width measuring circuit into a voltage value based on a relationship prescribed in advance between the pulse width and the voltage value, and outputting the voltage value; a current-voltage conversion circuit for converting a peak value of the provided detection signal into a voltage value; and a voltage comparison circuit for making a comparison between the voltage value converted by the current-voltage conversion circuit and the voltage value converted by the pulse width-voltage conversion circuit, and providing a result of the comparison.

Preferably, the processing device further accepts input of information about a flow speed of the particles suspended in the air within a radiation region of the light emitting element.

Preferably, the processing device further executes control processing for controlling a flow speed of the particles suspended in the air within a radiation region of the light emitting element to attain a predetermined speed.

Preferably, the processing device counts the particles determined as the particles of biological origin in the processing of performing the determination, and stores the count in the storage device.

More preferably, the processing device further executes calculation processing for obtaining a concentration of the particles of biological origin or a concentration of the particles not of biological origin based on the stored count obtained within a detection time and the flow speed of the particles suspended in the air.

Preferably, the processing device includes a filter circuit for removing a signal of an output value equal to or smaller than a preset value, and accepts input of the detection signal through the filter circuit.

Preferably, the detection apparatus further includes an introducing mechanism for introducing, at a predetermined speed, the air containing the particles into a region serving as both a radiation region of the light emitting element and a light receiving region of the light receiving unit, and the predetermined speed is a speed allowing a pulse width of the detection signal to reflect a size of the particles suspended in the air.

More preferably, the predetermined speed is in a range from 0.01 liter per minute to 10 liters per minute.

Preferably, the detection apparatus further includes a communication device for transmitting information to/from another device.

Preferably, the light receiving unit includes a first light receiving element having a light receiving direction of 0 degree with respect to the radiation direction of the light emitting element, and a second light receiving element having a light receiving direction of an angle larger than 0 degree with respect to the radiation direction of the light emitting element, and the processing device compares, in the processing of performing the determination, the detection signal provided from the second light receiving element with the condition corresponding to the detection signal provided from the first light receiving element.

According to another aspect of the invention, a detection method is a method of detecting microorganisms in an air by processing a detection signal corresponding to an amount of received light and provided from a light receiving element, and includes a step of receiving, by the light receiving element, scattered light caused by scattering the light radiated from a light emitting element by particles in the air moving at a predetermined speed, and inputting a detection signal corresponding to an amount of the received light; a step of comparing a peak value of the detection signal with a boundary value corresponding to the pulse with of the detection signal; a step of determining, based on a result of the comparison, whether the particles in the air are particles of biological origin or not; a step of counting the particles determined as the particles of biological origin; and a step of storing the count in a storage device.

### ADVANTAGEOUS EFFECTS OF INVENTION

According to the invention, it is possible to detect accurately, in real time, the microorganisms among the particles in the air by separating them from the dust.

### BRIEF DESCRIPTION OF DRAWINGS

FIG. 1 shows a specific example of an outer appearance of an air purifier that is a detection apparatus for detecting microorganisms according to an embodiment.

FIG. 2 shows a basic structure of a detection apparatus portion in the air purifier according to the embodiment.

FIG. 3 illustrates a result of simulation of a correlation between a scattering angle and a scattering intensity relating to dust particles and microorganism particles having the same size.

FIG. 4 shows another structure of the detection apparatus portion.

FIG. 5 shows a section of the structure in FIG. 4 taken in a direction of arrows in FIG. 4.

FIG. 6 is a block diagram showing a specific example of a functional structure of the detection apparatus.

FIG. 7 shows a specific example of a detection signal.

FIG. 8 illustrates a relationship between a pulse width and the scattering intensity.

FIG. 9A shows an example of display of a detection result.

FIG. 9B shows a method of displaying the detection result.

FIG. 10 is a flowchart showing a specific example of a detection method executed by the detection apparatus.

FIG. 11A shows another example of the system structure of the detection apparatus.

FIG. 11B shows another example of the system structure of the detection apparatus.

FIG. 12 illustrates a relationship between the pulse width and a voltage value proportional to the scattering intensity in the embodiment.

FIG. 13 is a perspective view schematically showing a conventional microorganism detection apparatus.

FIG. 14 is a block diagram schematically showing a functional structure of the conventional microorganism detection apparatus.

### DESCRIPTION OF EMBODIMENTS

Embodiments of the invention will now be described with reference to the drawings. In the following description, the same parts and components bear the same reference numbers. They bear the same names, and achieve the same functions.

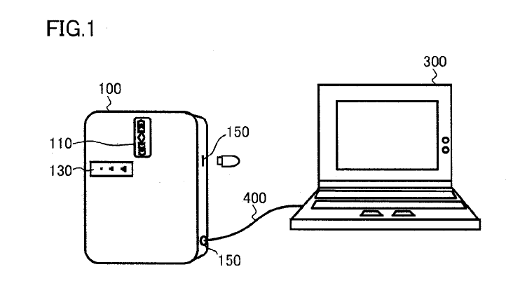

In the embodiment, an air purifier shown in FIG. 1 functions as a device (which will be referred to as a “detection apparatus” hereinafter) 100 for detecting microorganisms.

Referring to FIG. 1, the air purifier serving as detection apparatus 100 includes a switch 110 for accepting an operation instruction and a display panel 130 for displaying a detection result and others. Although not shown, it further includes a suction opening for introducing an air, an outlet for discharging the air and the like. Further, detection apparatus 100 includes a communication unit 150 for attaching a recording medium thereto. Communication unit 150 may be a unit for connecting a personal computer (PC) 300 or the like serving as an external device via a cable 400. Also, communication unit 150 may be a unit for connecting a communication line for performing communications with other devices over the Internet. Further, communication unit 150 may be a unit for performing communications with other devices through infrared communications or the Internet communications.

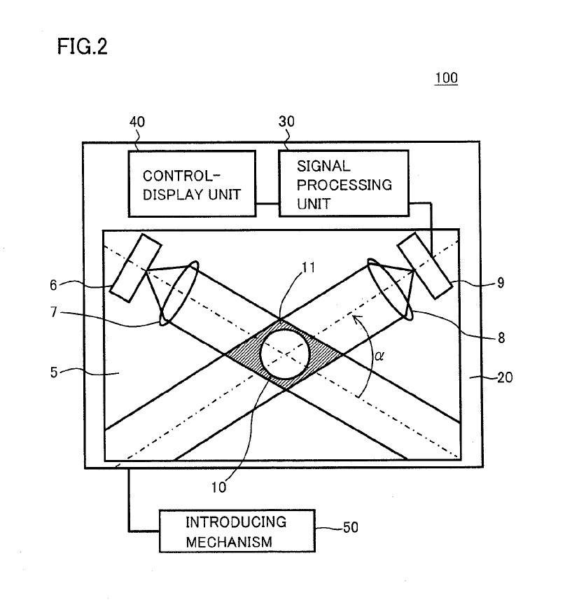

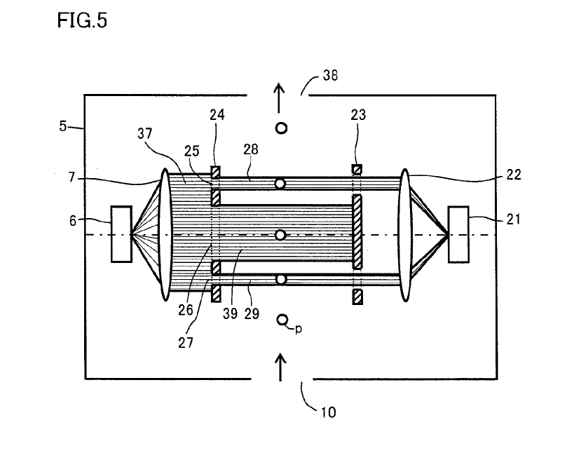

Referring to FIG. 2, detection apparatus 100 that is a detection apparatus portion in the air purifier has a case 5 provided with an inlet 10 for introducing the air through the suction opening and an outlet 38 (see FIG. 5) not shown in FIG. 2, and also includes a sensor 20, a signal processing unit 30 and a control-display unit 40 which are located inside case 5.

Detection apparatus 100 includes an introducing mechanism 50 for introducing the air. Introducing mechanism 50 introduces the air through the suction opening into case 5 at a predetermined flow speed. For example, introducing mechanism 50 may be a fan or a pump arranged outside case 5 as well as a drive mechanism for it, or the like. Further, it may be a thermal heater, a micro-pump or a micro-fan arranged in case 5 as well as a drive mechanism for it, or the like. Further, introducing mechanism 50 may have a configuration shared with an air introducing mechanism of the air cleaning device portion in the air purifier. Preferably, control-display unit 40 controls the drive mechanism included in introducing mechanism 50 to control the flow speed of the introduced air. The flow speed at which introducing mechanism 50 introduces the air is not restricted to a predetermined flow speed. Detection apparatus 100 converts a current signal provided from a light receiving element 9 into sizes of suspended particles in a manner to be described later, and therefore the flow speed must be controlled to fall within a range not exceeding an excessive value for allowing such conversion. Preferably, the flow speed of the introduced air is in a range from 0.01 lit/min to 10 lit/min.

Sensor 20 includes a light emitting unit 6 that is a light source, a collimate lens 7 that is arranged in a radiation direction of light emitting unit 6 for changing the light beams radiated from light emitting unit 6 into parallel light beams or light beams having a predetermined width, light receiving element 9, and a collecting lens 8 that is arranged in a light receiving direction of light receiving element 9 for condensing, on light receiving element 9, scattered light occurring from the parallel light beams due to suspended particles in the air.

Light emitting unit 6 includes a semiconductor laser or an LED (Light Emitting Diode) clement. The wavelength may be in any of ultraviolet, visible and ncar-infrared ranges. Light receiving element 9 may be a conventional element such as a photodiode or an image sensor.

Each of collimate lens 7 and collecting lens 8 may be made of synthetic resin or glass. The width of the parallel light beams produced by collimate lens 7 is not restricted to a specific value, but is preferably in a range from about 0.05 mm to about 5 mm.

When the light radiated from light emitting unit 6 has a wavelength in the ultraviolet range, an optical filter for filtering out fluorescence that is emitted from suspended particles of biological origin is arranged before collecting lens 8 or light receiving element 9 so that the fluorescence may not enter light receiving element 9.

Case 5 has a rectangular parallelepiped shape with the length of each side being 3 mm to 500 mm. Though case 5 has a rectangular parallelepiped shape in the present embodiment, the shape is not limited, and the case may have a different shape. Preferably, at least the inner side is painted black or treated with black alumite. This prevents reflection of light from the inner wall surface as a cause of stray light. Though the material of case 5 is not specifically limited, preferably, plastic resin, aluminum, stainless steel or a combination of these may be used. Inlet 10 and outlet 11 of case 5 have circular shape with the diameter of 1 mm to 50 mm. The shape of inlet 10 and outlet 11 is not limited to a circle, and it may be an ellipse or a rectangle.

Light emitting unit 6 and collimate lens 7 as well as light receiving element 9 and collecting lens 8 are arranged such that the radiation direction of the light beams emitted by light emitting unit 6 and collimated by collimate lens 7 keeps a predetermined angle α with respect to the direction in which light receiving element 9 can receive the light condensed by collecting lens 8. Further, they are angularly arranged such that the air moving from inlet 10 to outlet 38 may flow through a region 11 in FIG. 2 where the radiation region of the light emitted by light emitting unit 6 and collimated by collimate lens 7 overlaps a reception region where light receiving element 9 can receive the light condensed by collecting lens 8. FIG. 2 shows an example of the positional relationship where the angle α is about 60 degrees and region 11 is located in front of inlet 10. The angle α is not restricted to 60 degrees, and may be of another value.

Light receiving element 9 is connected to signal processing unit 30, and provides a current signal proportional to an amount of the received light to signal processing unit 30. In the structure shown in FIG. 2, the light radiated from light emitting unit 6 is scattered by the particles that are suspended in the air and are being moved in region 11 at a predetermined flow speed by introducing mechanism 50 from inlet 10 to outlet 38. Light receiving element 9 receives the light beams that are contained in the above scattered light and form an angle α of 60 degrees with respect to the radiation direction of light emitting unit 6, and detects the amount of the received light.

Signal processing unit 30 is connected to control-display unit 40, and provides a result of its processing performed on the pulse-like current signal to control-display unit 40. Based on the processing result provided from signal processing unit 30, control-display unit 40 performs the processing for displaying the measurement result on display panel 130.

A detection principle of detection apparatus 100 is described below.

An intensity of the light scattered by the suspended particles in the air depends on the size and the refraction factor of the suspended particles. Since the microorganisms that are the suspended particles of biological origin have cells filled with liquid similar to water, the microorganisms can be approximated as transparent particles having the refraction factor close to that of the water. Assuming that the suspended particles of biological origin have the refraction factor close to that of the water, detection apparatus 100 utilizes the difference which appears in scattering intensity at a specific scattering angle of the radiated light between the suspended particles of biological origin and the dust particles of the same sizes, and thereby discriminates between the suspended particles of biological origin and the other suspended particles for detecting the former.

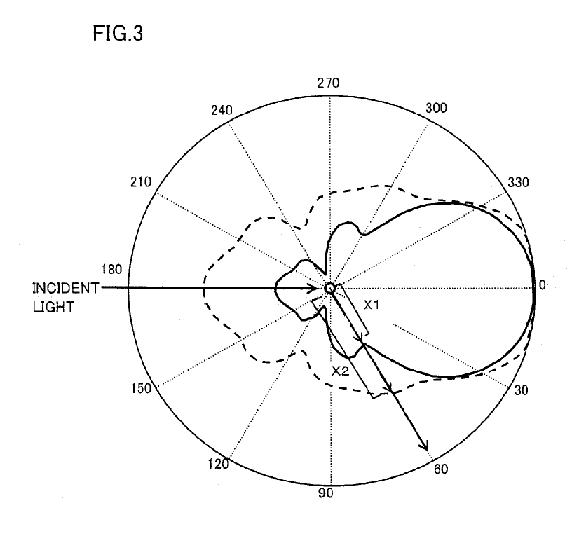

FIG. 3 shows a simulation result in which scattering intensity is plotted with various scattering angles in connection with spherical particles of 1 micron in diameter, and particularly in connection with particles of 1.3 in refraction factor close to that of the water and those of 1.6 in refraction factor different from that of water. In FIG. 3, thick line represents a result of simulation relating to the scattering intensity of the particles of 1.3 in refraction factor, and dotted line represents a result of simulation relating to the scattering intensity of the particles of 1.6 in refraction factor.

Referring to FIG. 3, from a comparison in scattering intensities at the scattering angle, e.g., of 60 degrees, it can be seen that a discriminative difference is present between a scattering intensity X1 of the particles exhibiting the refraction factor of 1.3, i.e., the particles of biological origin and a scattering intensity X2 of the particles exhibiting the refraction factor of 1.6 that are assumed as representative dust. Thus, when a value between scattering intensities X1 and X2 is used in advance as a boundary value, the scattering intensities at the scattering angle of 60 degrees of the spherical particles having a diameter of 1 micron can be determined such that the particles exhibiting the scattering intensities smaller than the boundary value are of biological origin, and the particles of larger scattering intensities are the dust particles.

Detection apparatus 100 applies this principle to the suspended particles in the introduced air to discriminate between the suspended particles of biological origin and other particles. For this, boundary values for discriminating between the suspended particles of biological origin and the other suspended particles are set in advance in detection apparatus 100 for various particle sizes, respectively. Detection apparatus 100 measures the sizes of the suspended particles in the introduced air as well as the scattering intensities, and determines that these are the particles of biological origin when the measured scattering intensity is smaller than the boundary value already set with respect to the measured size, and otherwise determines that the particles are the dust particles.

Detection apparatus 100 can detect the sizes of the suspended particles in the introduced air, using the following principle. When the flow speed of the air is not high, the speed of the suspended particles in the air flowing at a certain speed decreases with increase in size of the suspended particles, as is well known. According to this principle, when the size of the suspended particles increases, its speed decreases so that the time for which the suspended particle moves across the radiated light increases. Light receiving element 9 of detection apparatus 100 receives the scattered light that is generated by the suspended particles when the suspended particles moving at a certain flow speed move across the light radiated from light emitting unit 6. Accordingly, the current signal issued from light receiving element 9 takes a pulse-like form, of which pulse width correlates with the time for which the suspended particle moves across the radiated light. Accordingly, the pulse width of the issued current signal is converted into the size of the suspended particle. For allowing this conversion, control-display unit 40 controls the flow speed of the air introduced by introducing mechanism 50 to attain an unexcessive speed so that the pulse width of the current signal provided from light receiving element 9 may reflect the size of the suspended particle.

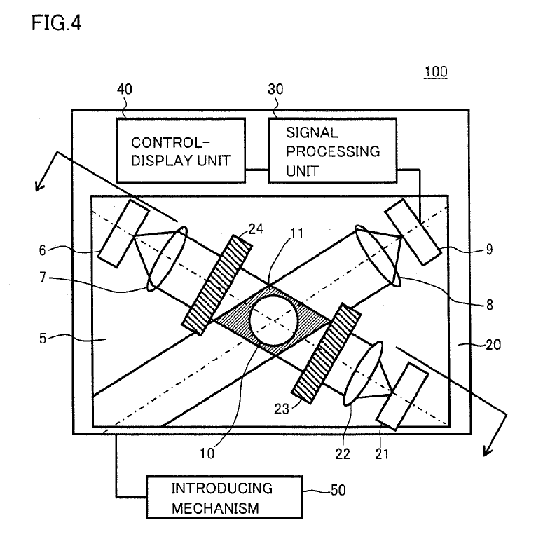

Another method for obtaining the information corresponding to the sizes of the particles can be implemented by a structure shown in FIG. 4. The structure in FIG. 4 includes, in addition to the structure shown in FIG. 2, a light receiving element 21 and a collecting lens 22 as well as two slits 23 and 24. Two slits 23 and 24 are arranged on the opposite sides of region 11, respectively, and are aligned in the radiation direction of light emitting unit 6. Light receiving element 21 is opposed to light emitting unit 6 with collecting lens 22 interposed therebetween for receiving the light radiated from light emitting unit 6.

FIG. 5 is a cross section taken in a direction of arrows in FIG. 4, i.e., taken from a position perpendicular to the radiation direction of light emitting unit 6. Inlet 10 is located on the lower side in FIG. 5, and outlet 38 is located on the upper side.

Referring to FIG. 5, slit 24 includes three apertures 25, 26 and 27 which are aligned, in this order, in the direction from outlet 38 to inlet 10. Slit 23 is provided with two apertures which are located in positions opposed to apertures 25 and 27 of slit 24, respectively. Beams 37 that are the light beams radiated from light emitting unit 6 pass through apertures 25, 26 and 27 of slit 24, and thereby are split into three kinds of beams 28, 29 and 39. Beams 28 and 29 pass through the apertures of slit 23, and are collected on light receiving element 21 through collecting lens 22. Beams 28 and 29 are used for obtaining information corresponding to the sizes of the particles. From the detection by light receiving element 21, the time for which the particle moves between beams 28 and 29 is measured, and thereby the information corresponding to the size of the particle can be obtained. Slit 23 intercepts beam 39. Thereby, beam 39 between beams 28 and 29 do not enter light receiving element 21. Beam 39 is used for measuring the scattered light.

A method in which the structures in FIGS. 4 and 5 obtain the information corresponding to the particle sizes will be described below. An external air is introduced into case 5 through inlet 10, and is discharged through outlet 38. For example, in FIG. 5, when a suspended particle p is introduced into case 5, particle p moves in a direction of an arrow in FIG. 5. When particle p moves, it passes through beams 29. At this time, an amount of light entering light receiving element 21 decreases due to the passing of particle p. Thereby, a signal of a pulse-like form, i.e., a pulse signal P1 is detected from the received light amount of light receiving element 21. Then, particle p passes through beams 39. At this time, the scattered light occurs. This scattered light is received by light receiving element 9, and is intercepted by slit 23 so that light receiving element 21 does not receive it. Then, particle p passes through beams 28. At this time, the amount of light entering light receiving element 21 lowers due to passing of particle p. Thereby, a signal of a pulse-like form, i.e., a pulse signal P2 is detected from the amount of light received by light receiving element 21. A passing time T of particle p which is a difference between times when pulse signals P1 and P2 appear, respectively, depends on the size of the particle as described before. Accordingly, passing time T can be used in substitution for the pulse width obtained by the structure in FIG. 2.

The structure in FIGS. 4 and 5 is more complicated than that in FIG. 2. Therefore, the method using the pulse width as illustrated in FIG. 2 is simpler than the method that uses passing time T as illustrated in FIGS. 4 and 5. However, there is fear that, even when the particle sizes are uniform, a slight difference occurs in pulse width between the case where the particle passes through a center of the beam and the case where it passes through an end of the beam. Conversely, according to the method using passing time T as illustrated in FIGS. 4 and 5, beams 29 and 28 determine the distance which the particle moves, and therefore an error is unlikely to occur in passing time T corresponding to the particle size, resulting in an advantage that the particle size can be accurately reflected.

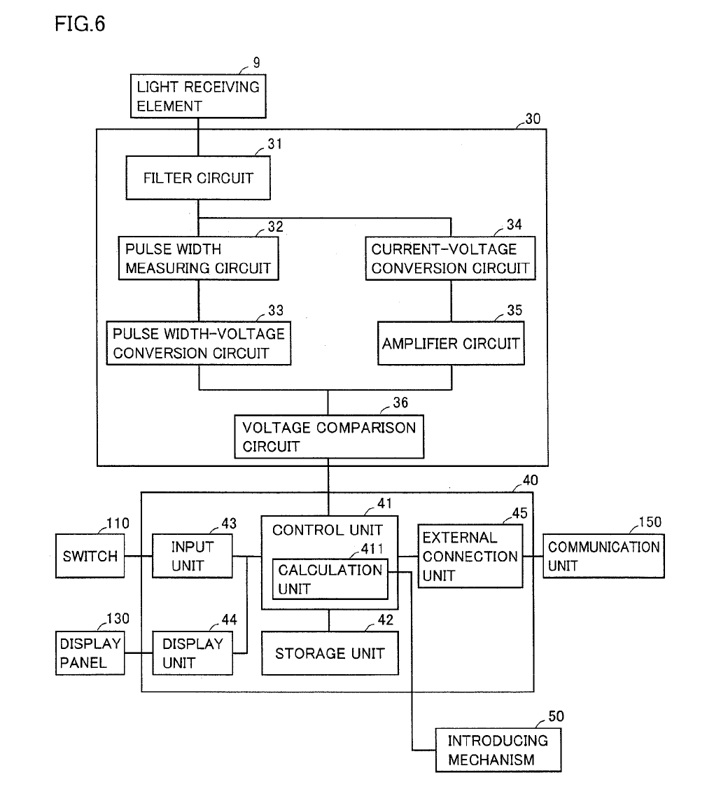

A functional structure of detection apparatus 100 that uses the structure in FIG. 2 for detecting the microorganisms in the air will be described below with reference to FIG. 6. FIG. 6 shows an example in which the functions of signal processing unit 30 are implemented by hardware configuration mainly of electric circuitry. However, at least part of the functions may be implemented by software configuration realized by a CPU (Central Processing Unit) which is not shown, provided in signal processing unit 30, executing a predetermined program. In the illustrated example, the structure of control-display unit 40 is a software structure. However, a hardware structure such as an electric circuit may implement at least a part of such function.

Referring to FIG. 6, signal processing unit 30 includes a pulse width measuring circuit 32 connected to light receiving element 9, a pulse width-voltage conversion circuit 33 connected to pulse width measuring circuit 32, a current-voltage conversion circuit 34 connected to light receiving element 9, an amplifier circuit 35 connected to current-voltage conversion circuit 34 and a voltage comparison circuit 36 connected to pulse width-voltage conversion circuit 33 and amplifier circuit 35. Preferable, as shown in FIG. 6, a filter circuit 31 for removing signals of current values smaller than a preset value is arranged between light receiving element 9 on one side and pulse width measuring circuit 32 and current-voltage conversion circuit 34 on the other side. The provision of filter circuit 31 can reduce noise components in the detection signal of light receiving element 9 due to stray light.

Control-display unit 40 includes a control unit 41 and a storage unit 42. Further, control-display unit 40 includes an input unit 43 for accepting input of information by accepting an input signal that is provided from switch 110 according to an operation of switch 110, a display unit 44 for executing processing of displaying measurement results and others on display panel 130, and an external connection unit 45 for performing processing required for transmitting data and others to or from external devices connected to communication unit 150.

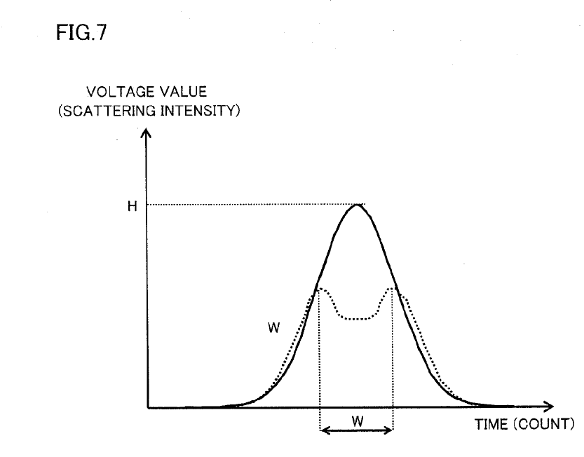

When light emitting unit 6 irradiates the suspended particles introduced into case 5 with the light, light receiving element 9 collects the light scattered by the suspended particles in region 11 shown in FIG. 2. Light receiving element 9 provides the pulse-like current signal shown in FIG. 7 and corresponding to the amount of received light to signal processing unit 30. The current signal is provided to pulse width measuring circuit 32 and current-voltage conversion circuit 34 of signal processing unit 30. Among the current signals provided from light receiving element 9, the signals of the current values smaller than the preset value are filtered out by filter circuit 31.

Current-voltage conversion circuit 34 detects a peak current value H representing the scattering intensity from the current signal provided from light receiving element 9, and converts it into a voltage value Eh. Amplifier circuit 35 amplifies voltage value Eh with a preset amplification factor, and provides it to voltage comparison circuit 36.

Pulse width measuring circuit 32 measures a pulse width W of the current signal provided from light receiving element 9. The method of measuring the pulse width or the value related to it by pulse width measuring circuit 32 is not restricted to a specific method, and may be a well-known signal processing method. By way of example, description will be made on a measuring method in the case where a differentiation circuit (not shown) is arranged in pulse width measuring circuit 32. When the pulse-like electric signal is applied, the differentiation circuit generates a certain voltage determined corresponding to the initial pulse signal, and this voltage will return to zero in response to a next pulse signal. Pulse width measuring circuit 32 measures a time between the rising and the falling of the voltage signal that occurs in the differentiation circuit, and can use it as the pulse width. Thus, pulse width W may be a width between peaks of a differentiation curve that is obtained using the differentiation circuit, as represented, e.g., by dotted line in FIG. 7. In other examples, pulse width W may be an interval between halves of the peak voltage values of the pulse waveform, i.e., may be a half-value width, and also may be an interval between the rising and falling of the pulse waveform. The signal indicative of pulse width W that is measured according to one of these or other methods is provided to pulse width-voltage conversion circuit 33.

In pulse width-voltage conversion circuit 33, a voltage value Ew to be used as a boundary value of the scattering intensity for determining whether the suspended particles are of biological origin or not is set in advance for each pulse width W. Pulse width-voltage conversion circuit 33 converts pulse width W provided thereto into voltage value Ew according to the above setting. The correlation between pulse width W and voltage value Ew may be set as a function or a coefficient, and may also be set in a table. As described below, voltage value Ew with respect to a predetermined pulse width is experimentally determined. For example, when the sensor is used solely, it is set to a predetermined flow rate so that the relationship between the pulse width corresponding to the flow rate thus set and voltage value Ew can be used. However, when a fan of the air purifier is used as the air introducing mechanism, the power of the fan, i.e., the flow rate varies according to the degree of air cleaning. When the flow speed varies, the pulse width of the signal varies even when the particle diameter is constant. Therefore, a relationship between the pulse width and voltage value Ew is set in advance with respect to predetermined flow speeds, and a table representing the relationships between the pulse width and voltage value Ew at various flow speeds is stored. In this case, the information about the flow speed of the air purifier is obtained, and the appropriate relationship between the pulse width and voltage value Ew is selected according to such information. Voltage value Ew is provided to voltage comparison circuit 36.

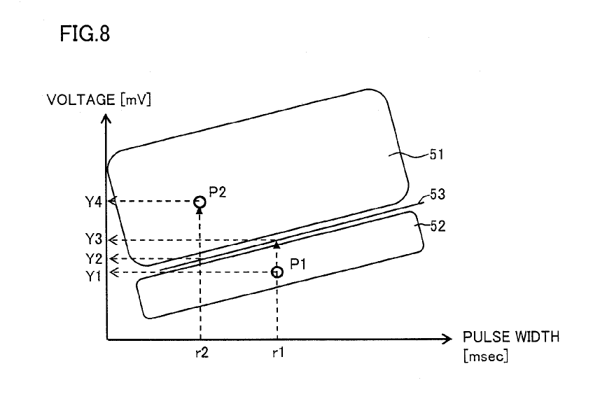

Voltage value Ew that is the boundary value corresponding to pulse width W is experimentally determined in advance. By way of example, one type of microorganism such as Escherichia coli, Bacillius subtilis or Penicillium is sprayed using a nebulizer in a vessel having the size of, and detection apparatus 100 measures the pulse width and the scattering intensity (peak voltage value) from the current signal provided from light receiving element 9. Likewise, polystyrene particles having uniform sizes are used in place of dust, and detection apparatus 100 measures the pulse width and the scattering intensity (peak voltage value). FIG. 8 is a diagram prepared by plotting the scattering intensities (peak voltage values) with respect the pulse widths, and particularly the scattering intensities that are obtained by detection apparatus 100 from the microorganisms and the polystyrene particles. In a region 51 of FIG. 8, the scattering intensities that are correlated to the pulse widths obtained from the polystyrene particles are plotted. In a region 52, the scattering intensities that are correlated to the pulse widths obtained primarily from the microorganisms are plotted. In practice, plotted intensities in each kind of region are partially located in the other kind of region, and are mixed with the other kind of intensities. This is due to variations in flow speed of the air introduced into case 5, variations in route of suspended particle moving across the radiated light, distribution of the intensity of the radiated light and others. Since regions 51 and 52 are experimentally obtained, the boundary between them is determined. e.g., as straight line 53. For example, a function or a coefficient representing straight line 53 is set in pulse width-voltage conversion circuit 33.

The correlation that is present between pulse width W and voltage value Ew and is represented by straight line 53 may be set in voltage comparison circuit 36 by control-display unit 40 in such a manner that the correlation is entered by operating switch 110 and others, and is accepted by input unit 43 of control-display unit 40 to be described later. Also, it may be set by control-display unit 40 in such a manner that a recording medium storing the correlation between pulse width W and voltage value Ew is attached to communication unit 150, and is read by external connection unit 45 of control-display unit 40 to be described later. Further, it may be set by control-display unit 40 in such a manner that it is entered and transmitted by PC 300, and is accepted by external connection unit 45 through cable 400 connected to communication unit 150. When communication unit 150 can perform infrared communications and/or the Internet communications, external connection unit 45 may accept the correlation through communication unit 150 from another device to set it by control-display unit 40. Further, control-display unit 40 may update the correlation that was once set between pulse width W and voltage value Ew by voltage comparison circuit 36.

Voltage comparison circuit 36 makes a comparison between voltage value Eh that is provided from current-voltage conversion circuit 34 through amplifier circuit 35 and is indicative of the scattering intensity and voltage value Ew that is provided from pulse width-voltage conversion circuit 33 and is the boundary value corresponding to pulse width W. Based on this comparison, voltage comparison circuit 36 determines whether the suspended particles that cause the scattered light received by light receiving element 9 are of biological origin or not, i.e., are microorganisms or not.

A practical example of the determination method in voltage comparison circuit 36 will be described below with reference to FIG. 8. For example, when a pulse width r1 and a scattered light intensity, i.e., a peak voltage value Y1 are detected from a certain suspended particle P1, pulse width-voltage conversion circuit 33 converts pulse width r1 into a voltage value Y3 based on the correlation represented by straight line 53 that has been set. Voltage comparison circuit 36 receives peak voltage values Y1 and voltage value Y3, and makes a comparison between them. Since peak voltage value Y1 is smaller than voltage value Y3 that is the boundary value, it is determined that particle P1 is of biological origin, i.e., that it is a microorganism.

For example, when a pulse width r2 and a scattered light intensity, i.e., a peak voltage value Y4 are detected from certain suspended particle P2, pulse width-voltage conversion circuit 33 converts pulse width r2 into voltage value Y2 based on the correlation represented by straight line 53 that has been set. Voltage comparison circuit 36 receives peak voltage value Y4 and voltage value Y2, and makes a comparison between them. Since peak voltage value Y4 is larger than voltage value Y2 that is the boundary value, it is determined that particle P2 is not of biological origin.

Voltage comparison circuit 36 performs the determination based on the light scattered by the suspended particle every time the particle moves across the light emitted by light emitting unit 6, and provides the signal indicative of the determination result to control-display unit 40. Control unit 41 of control-display unit 40 accepts the input of the determination results provided from voltage comparison circuit 36, and successively stores them in storage unit 42.

Control unit 41 includes a calculation unit 411. Calculation unit 411 performs calculation on the determination result that is obtained for a predetermined detection time and is stored in storage unit 42, and specifically it counts the input of the signal indicative of the determination result that the suspended particle of the measurement target is a microorganism, and/or counts the input of signal indicative of the determination result other than the above.

Calculation unit 411 reads the flow speed of the air introduced through introducing mechanism 50, and multiplies it by the above detection time to obtain a quantity Vs of the air introduced into case 5 for the above detection time. Calculation unit 411 obtains, as the measurement result, a concentration Ns/Vs of the microorganisms or a concentration Nd/Vs of the dust particles by dividing the result of the above counting, i.e., a number Ns of the microorganisms or a number Nd of the dust particles by air quantity Vs.

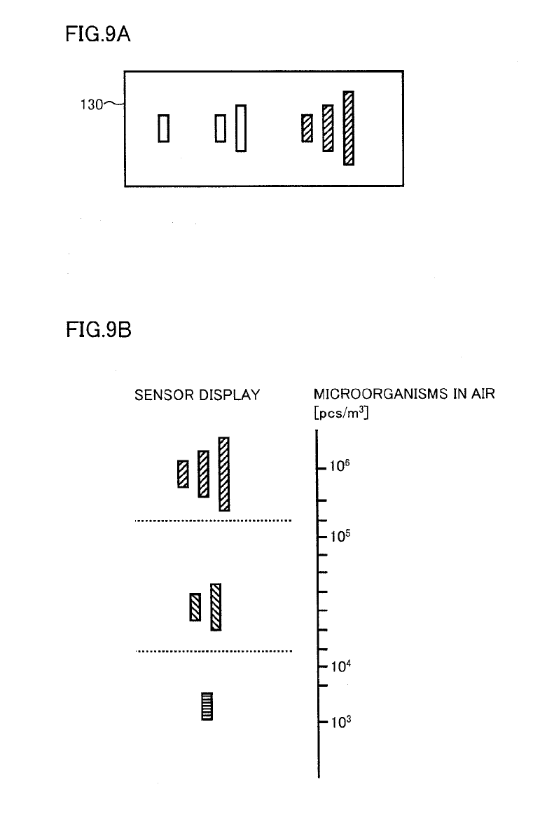

Display unit 44 performs the processing for displaying, on display panel 130, the measurement results, i.e., the numbers Ns and Nd of the microorganisms and the dust particles counted for the above detection time as well as the calculated concentrations Ns/Vs and Nd/Vs of the microorganisms and the dust particles. For example, sensor display shown in FIG. 9A may be employed as an example of the display by display panel 130. Specifically, display panel 130 is provided with lamps for the respective concentrations. As shown in FIG. 9B, display unit 44 determines, as the lamp to be turned on, the lamp corresponding to the calculated concentration and number, and turns on the lamp thus determined. In another example, the lamps may be configured to be turned on in different colors corresponding to the measured numbers of particles or the calculated concentrations, respectively. Display panel 130 is not restricted to the lamp display, and may be configured to display numerals or to display messages that are prepared in advance corresponding to the concentrations and the numbers. The measurement result may be written onto a record medium attached to communication unit 150 through external connection unit 45, or may be transmitted to PC 300 through cable 400 connected to communication unit 150.

Input unit 43 may accept the selection of the display method of display panel 130 according to an operation signal provided from switch 110. It may also accept the selection between the display of the measurement result on display panel 130 and the output thereof to the external device. A signal indicative of the contents thereof is provided to control unit 41, which provides a required control signal to display unit 44 and/or external connection unit 45.

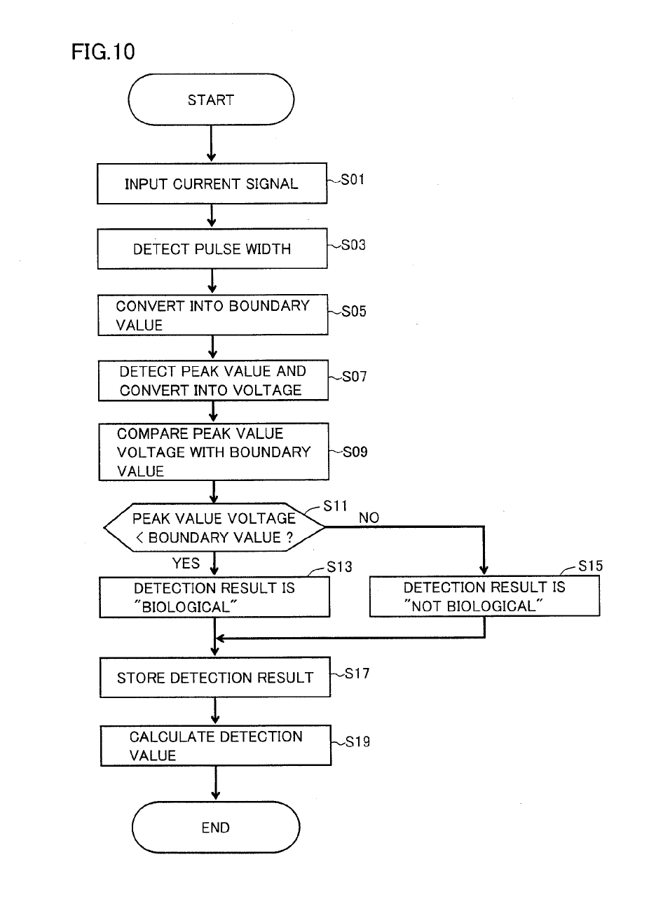

A specific example of the detection method in detection apparatus 100 will be described below with reference to FIG. 10. The detection method in FIG. 10 is implemented by such operations that signal processing unit 30 and control-display unit 40 receive a control signal from an arithmetic unit such as a CPU which is included in detection apparatus 100 but is not shown in the figure, and thereby the various circuits and functions illustrated in FIG. 6 are implemented according to the received control signal.

Referring to FIG. 10, the suspended particles carried by the moving air move across the light radiated from light emitting unit 6. Thereby, when the current signal that is caused by the scattered light generated by the suspended particles is provided from light receiving element 9 to signal processing unit 30 through filter circuit 31 in a step (which will be simply expressed as “S” hereinafter) 01, pulse width measuring circuit 32 detects a pulse width W of this pulse-like current signal in S03. In S05, pulse width-voltage conversion circuit 33 converts pulse width W detected in S03 into the boundary value, i.e., voltage value Ew based on the correlation that is set in advance.

In S07, current-voltage conversion circuit 34 detects peak current value H indicative of the scattering intensity from the pulse-like current signal that is provided from light receiving element 9 in S01, and converts it into peak voltage value Eh. The order of steps S03-S07 is not restricted to the above order.

Amplifier circuit 35 amplifies voltage value Eh obtained in S07 at a preset amplification factor and, in S09, voltage comparison circuit 36 compares it with voltage value Ew obtained in S05. As a result, when the peak voltage value is smaller than the boundary value (YES in S11), voltage comparison circuit 36 determines that the suspended particles that generate the scattered light detected as the current signal in question are of biological origin, and the signal indicative of the result thereof is provided to control-display unit 40. Conversely, when the peak voltage value is larger than the boundary value (NO in S11), voltage comparison circuit 36 determines that the suspended particles are not of biological origin, and provides the signal indicative of the result to control-display unit 40.

In S17, storage unit 42 of control-display unit 40 stores the result of detection provided from voltage comparison circuit 36 in S13 or S15. In S19, calculation unit 411 performs the operation on the determination results that are obtained for the predetermined detection time and are stored in storage unit 42, and specifically counts the inputs of the determination result indicating that the suspended particles are of biological origin and/or the inputs of the determination result indicating that they are not of biological origin. The result of the former counting is handled as number Ns of the microorganisms, and the result of the latter counting is handled as number Nd of the dust particles. Further, calculation unit 411 multiplies the above detection time by the flow speed of the air to obtain quantity Vs of the air introduced into case 5 for the above detection time. Therefore, by dividing number Ns or Nd of the microorganisms or the dust particles obtained by the counting by air quantity Vs, concentration Ns/Vs of the microorganisms or concentration Nd/Vs of the dust particles are obtained as the detection value.

By performing the determination about the microorganisms and the dust as described above, detection apparatus 100 can separate the microorganisms among the suspended particles in the air from the dust and can accurately detect them in real time. By using detection apparatus 100 in the air purifier as illustrated in FIG. 1, it can perform the management and control of the quantities of the microorganisms and dust in the environment where the air purifier is placed, and can provide healthful and safe living. Further, detection apparatus 100 can display the measurement results in real time as described above so that a person performing the measurement can grasp the measurement results in real time. Consequently, the quantities of the microorganisms and dust in the environment in question can be effectively managed and controlled.

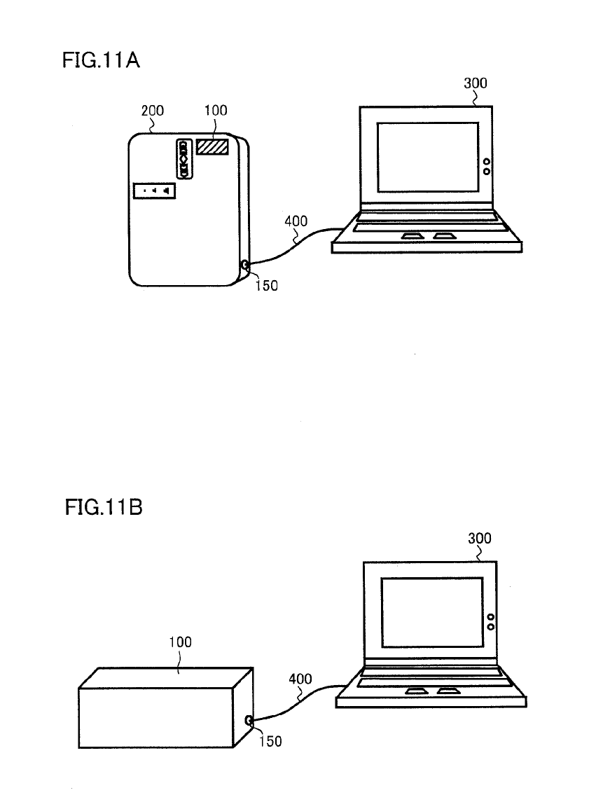

As another example, detection apparatus 100 may be arranged in an air purifier 200 as shown in FIG. 11A. In addition to the air purifier, it can be arranged in an air conditioner. As shown in FIG. 11B, detection apparatus 100 can be solely used.

### Examples

A practical example of the invention will be described below further in detail, but the practical example does not restrict the invention.

According to the specifications of detection apparatus 100 used in the practical example, case 5 is made of aluminum and has a rectangular parallelepipedal form having outer sizes of (100 mm×50 mm×50 mm). A light source of light emitting unit 6 is semiconductor laser of 680 nm in wavelength, and light receiving element 9 is a pin-photodiode. The radiation direction of light emitting unit 6 and the direction in which light receiving element 9 can receive the light forms an angle α equal to 60 degree. Each of inlet 10 and the outlet has a diameter of 3 mm. A flow rate is 0.1 lit/min (linear speed is about 20 mm/sec). Signal processing unit 30 includes the circuit in FIG. 6.

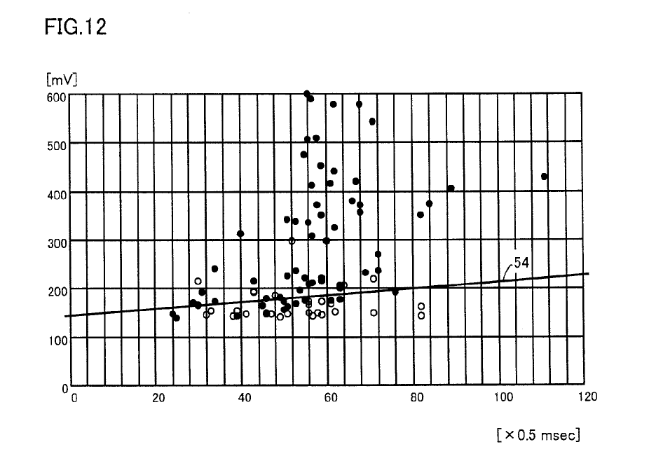

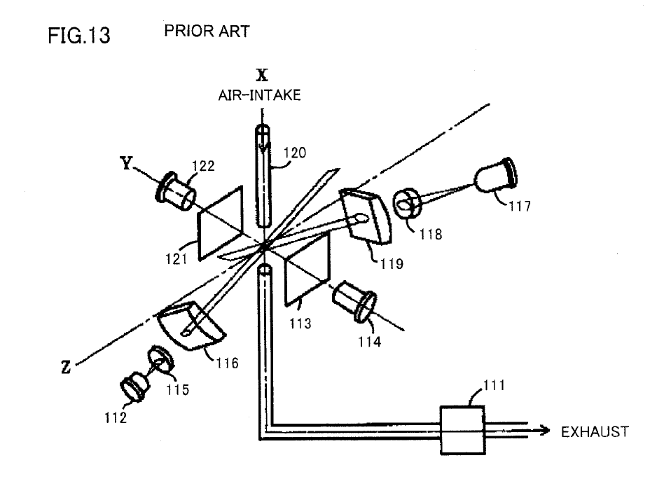

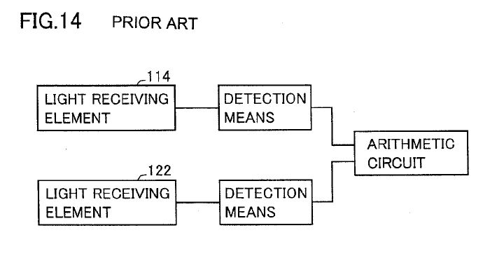

First, a nebulizer was used to spray colibacilli into a container of 1 m³ to achieve a concentration of 10,000 pcs/m³. Detection apparatus 100 was used to measure the pulse width and the peak voltage value from the current signal provided from light receiving element 9. White circles are plotted in FIG. 12 to indicate the scattering intensities (peak voltage values) measured from the colibacilli with respect to the pulse widths. The pulse width in FIG. 12 is indicated by the count number, and the unit is 0.5 millisecond (msec) per 1 count. The unit of the peak voltage value is millivolt (mV).

Then, polystyrene particles of different diameters of 1 μm, 1.5 μm and 3 μm were sprayed as the dust to achieve similar concentrations, respectively, and detection apparatus 100 was used to measure the pulse widths and the peak voltage values from the current signals provided from light receiving element 9. Black circles in FIG. 12 are plotted to indicate the scattering intensities (peak voltage values) measured with respect to the pulse widths from the polystyrene particles of 1 μm, 1.5 μm and 3 μm in diameter.

From the result of measurement shown in FIG. 12, it could be confirmed that colibacilli were plotted and distributed primarily below a boundary defined by straight line 54, similarly to FIG. 8, and the polystyrene, i.e., the dust is plotted and distributed primarily above it. Thereby, it could be understood that the detection principle employed in detection apparatus 100 was effective.

Using the result of measurement of FIG. 12, the following measurement was performed in this practical example. Specifically, the relationship of straight line 54 in FIG. 12, i.e., the correlation between the pulse width and the voltage value was set in pulse width-voltage conversion circuit 33 of detection apparatus 100. Using the nebulizer, bacilli were sprayed into a container of 1 m³ to attain the concentration of about 10,000 pcs/m³. Detection apparatus 100 was used to detect bacilli, and the discrimination could be performed at an accuracy of about 70% or more. It could be understood form this that detection apparatus 100 could detect the microorganisms.

### REFERENCE SIGNS LIST

5 case; 6 light emitting unit; 7 collimate lens; 8 and 22 collecting lens; 9 and 21 light receiving element; 10 inlet; 11 region, 20 sensor; 23 and 24 slit; 25, 26 and 27 aperture; 28, 29, 37 and 39 beam; 30 signal processing unit; 31 filter circuit; 32 pulse width measuring circuit; 33 pulse width-voltage conversion circuit; 34 current-voltage conversion circuit; 35 amplifier circuit; 36 voltage comparison circuit; 38 outlet; 40 control-display unit; 41 control unit; 42 storage unit; 43 input unit; 44 display unit; 45 external connection unit; 50 introducing mechanism; 51 and 52 region; 53 and 54 straight line; 100 detection apparatus; 110 switch; 130 display panel; 150 communication unit; 300 PC; 400 cable; p particle

1-17. (canceled)

18. A detection apparatus for detecting particles of biological origin among particles suspended in an air, comprising:
a light emitting element;
a light receiving unit having a light receiving direction forming a predetermined angle with respect to a radiation direction of said light emitting element;
a processing device for processing an amount of received light of said light receiving unit as a detection signal; and
a storage device, wherein
when said processing device accepts input of said detection signal representing the received light amount of said light receiving unit, said processing device executes processing of comparing said detection signal with a boundary value set based on a correlation with a pulse width of the detection signal, and thereby determining whether the particles suspended in said air are of biological origin or not, and stores a result of the determination in said storage device.

19. The detection apparatus according to claim 18, wherein
said light receiving unit receives the light caused by scattering by particles suspended in said air among the light emitted by said light emitting element, and
further comprising a filter for filtering out light of a fluorescent wavelength directed toward said light receiving unit.

20. The detection apparatus according to claim 18, wherein
said processing device compares, in said processing of performing said determination, a peak value of said detection signal with said boundary value, and determines, based on a result of said comparison, whether the particles suspended in said air are the particles of biological origin or not.

21. The detection apparatus according to claim 20, wherein
said processing device includes a conversion device for storing a correlation between the pulse width and the boundary value, and converting the pulse width of said detection signal into the boundary value based on said correlation.

22. The detection apparatus according to claim 21, further comprising:
an input device for accepting the input of said correlation.

23. The detection apparatus according to claim 21, wherein
said processing device further executes processing of updating said stored correlation.

24. The detection apparatus according to claim 20, wherein
said processing device includes:
a pulse width measuring circuit for measuring the pulse width from said received detection signal;
a pulse width-voltage conversion circuit for converting a pulse width value provided from said pulse width measuring circuit into a voltage value based on a relationship prescribed in advance between the pulse width and the voltage value, and outputting said voltage value;
a current-voltage conversion circuit for converting a peak value of said provided detection signal into a voltage value; and
a voltage comparison circuit for making a comparison between said voltage value converted by said current-voltage conversion circuit and said voltage value converted by said pulse width-voltage conversion circuit, and providing a result of said comparison.

25. The detection apparatus according to claim 18, wherein said processing device further accepts input of information about a flow speed of the particles suspended in said air within a radiation region of said light emitting element.

26. The detection apparatus according to claim 25, wherein
said processing device counts the particles determined as the particles of biological origin in said processing of performing the determination, and stores said count in the storage device.

27. The detection apparatus according to claim 26, wherein said processing device further executes calculation processing for obtaining a concentration of said particles of biological origin or a concentration of the particles not of biological origin based on said stored count within said detection time and the flow speed of the particles suspended in said air.

28. The detection apparatus according to claim 18, wherein said processing device further executes control processing for controlling a flow speed of the particles suspended in said air within a radiation region of said light emitting element to attain a predetermined speed.

29. The detection apparatus according to claim 28, wherein
said processing device counts the particles determined as the particles of biological origin in said processing of performing the determination, and stores said count in the storage device.

30. The detection apparatus according to claim 29, wherein said processing device further executes calculation processing for obtaining a concentration of said particles of biological origin or a concentration of the particles not of biological origin based on said stored count within said detection time and the flow speed of the particles suspended in said air.

31. The detection apparatus according to claim 18, wherein
said processing device includes a filter circuit for removing a signal of an output value equal to or smaller than a preset value, and accepts input of said detection signal through said filter circuit.

32. The detection apparatus according to claim 18, further comprising:
an introducing mechanism for introducing, at a predetermined speed, the air containing said particles into a region serving as both a radiation region of said light emitting element and a light receiving region of said light receiving unit, wherein
said predetermined speed is a speed allowing a pulse width of said detection signal to reflect a size of the particles suspended in said air.

33. The detection apparatus according to claim 32, wherein
said predetermined speed is in a range from 0.01 liter per minute to 10 liters per minute.

34. The detection apparatus according to claim 18, further comprising:
a communication device for transmitting information to/from another device.

35. The detection apparatus according to claim 18, wherein
said light receiving unit includes a first light receiving element having a light receiving direction of 0 degree with respect to the radiation direction of said light emitting element, and a second light receiving element having a light receiving direction of an angle larger than 0 degree with respect to the radiation direction of said light emitting element, wherein
said processing device compares, in said processing of performing said determination, the detection signal provided from said second light receiving element with the condition corresponding to the detection signal provided from said first light receiving element.

36. A method of detecting microorganisms in an air by processing a detection signal corresponding to an amount of received light and provided from a light receiving element, comprising:
a step of receiving, by said light receiving element, scattered light caused by scattering the light radiated from a light emitting element by particles in the air moving at a predetermined speed, and inputting a detection signal corresponding to an amount of the received light;
a step of comparing a peak value of said detection signal with a boundary value set based on a correlation with a pulse width of said detection signal;
a step of determining, based on a result of said comparison, whether the particles in said air are particles of biological origin or not;
a step of counting the particles determined as the particles of biological origin; and
a step of storing said count in a storage device.
